(19) United States
(12) Patent Application Publication
(10) Pub. No.: US 2010/0038560 A1
(43) Pub. Date: Feb. 18, 2010

(54) LASER CLEANING APPARATUS AND LASER CLEANING METHOD

(75) Inventors: Fumihiko Tokura, Kawasaki (JP); Katsuhiko Kikuchi, Shinjuku (JP); Yuji Akasaki, Shinjuku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: FUJITSU LIMITED, Kawasaki-shi (JP); FUJITSU MICROELECTRONICS LIMITED, Tokyo (JP)

(21) Appl. No.: 12/508,140

(22) Filed: Jul. 23, 2009

(30) Foreign Application Priority Data
Aug. 18, 2008 (JP) 2008-210119

(51) Int. Cl. G21G 5/00

(52) U.S. Cl. 250/492.1

(57) ABSTRACT

A probe cleaning apparatus includes a cleaning-conditions database. The probe cleaning apparatus removes contamination from a probe by irradiating the probe by a laser beam, refers to the cleaning-conditions database based on information about the probe, such as material and shape, and controls properties of the laser beam, such as output intensity, pulse interval, wavelength, and pulse width, so that the probe cleaning apparatus removes the contamination from the probe without damaging the probe by heat.

### CROSS-REFERENCE TO RELATED APPLICATION

This application is based upon and claims the benefit of priority of the prior Japanese Patent Application No. 2008-210119, filed on Aug. 18, 2008, the entire contents of which are incorporated herein by reference.

### FIELD

The embodiments discussed herein are directed to a laser cleaning apparatus and a laser cleaning method.

### BACKGROUND

In a typical test for measuring electrical characteristics of a test object with a probe needle, a probe needle with a metal attached at its tip comes into contact with the test object, such as a substrate including for example, an integrated circuit, a semiconductor device, a liquid crystal display, a magnetic head, a thin film head and so forth. The metal of the probe needle is, for example, tungsten or palladium. There are a variety of probe needles used, each having different shapes of tips, different arrangements of needles, and a different number of actual needles.

In some cases, when the probe needle comes into contact with the test object, a metallic particle, such as an aluminum or gold particle, is removed from the test object and becomes attached to the probe needle near the tip. These foreign bodies that become attached to the probe needle (hereinafter, “contamination”) change the contact resistance between the probe needle and the test object, and this change decreases the accuracy of the test.

The contamination or debris has various sizes. The probe needle picks up or accumulates more contamination as the probe needle is used in more tests. The states of contamination of each probe needle are various. Therefore, as the probe needle is used in more tests and comes into contact with more test pieces, an increase in the length of the probe needle at the contact point with the test pieces gets larger. This results in unstable measurement.

To remove the contamination from the tip of the probe needle, probe cleaning using a laser beam has been used. In probe cleaning, the tip of the probe needle is irradiated with a laser beam. For example, in the conventional technology disclosed in Japanese Laid-open Patent Publication No. 11-326461, 1 to 100 shots of a pulsed laser beam having an energy 100 millijoules (mJ) per square centimeter or greater irradiate the tip of the probe needle from the side or front of the tip.

However, when the delicate tip of the probe needle is irradiated by a laser beam under the above conditions, the laser beam irradiates not only the contamination but also the surface of the probe needle that has no contamination and the surface revealed under the contamination that is removed. The surface of the tip is damaged, i.e., melted by heat generated by the laser beam. If the laser beam has an enough high energy density, only one shot of the laser beam damages the surface of the tip. The damage due to the heat changes load partitioning and load distribution between the probe needle and the test piece with which the probe needle is in contact, which causes the test to fail.

Therefore, with conventional technology, the object (test piece) is damaged by heat generated during irradiation by the laser beam.

### SUMMARY

According to an aspect of an embodiment of the present invention, a laser cleaning apparatus includes a laser-beam emitting unit that emits a laser beam to irradiate an object so that contamination is removed from a surface of the object; and an irradiation control unit that controls irradiation by the laser beam based on information about the object so that an effect of the irradiation on the object is limited.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a probe cleaning apparatus as a laser cleaning apparatus according to a first embodiment;

FIG. 2 is a schematic diagram for explaining how contaminations are attached to a probe;

FIG. 3 is a schematic diagram for explaining probe cleaning by laser irradiation;

FIG. 4 is a pulse diagram of a laser beam;

FIG. 5 is a flowchart for explaining a cleaning process performed by a cleaning control unit;

FIG. 6 is a graph for explaining probe protection that is achieved by controlling a pulse interval step by step;

FIG. 7 is a graph for explaining probe protection that is achieved by gradually increasing the pulse interval;

FIG. 8 is a block diagram of a probe cleaning apparatus including a cooling unit according to a second embodiment; and

FIG. 9 is a pulse diagram for explaining combination of different patterns of laser irradiation conditions.

### DESCRIPTION OF EMBODIMENTS

Exemplary embodiments of the present invention are described in detail below with reference to the accompanying drawings.

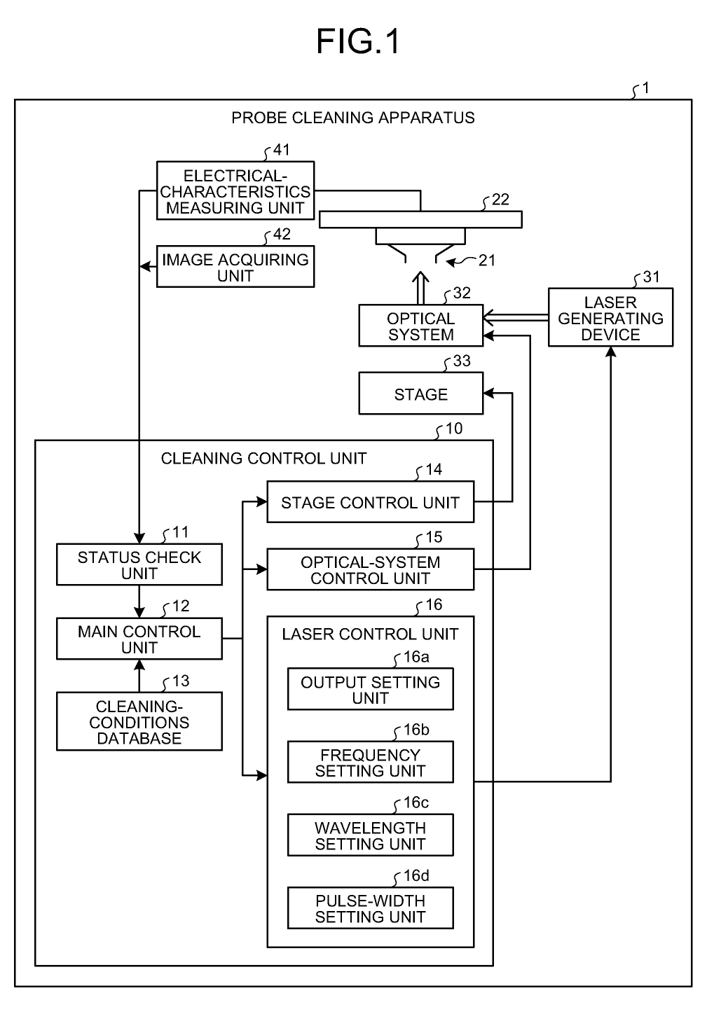

FIG. 1 is a block diagram of a probe cleaning apparatus 1 according to a first embodiment. The probe cleaning apparatus 1 corresponds to a laser cleaning apparatus. The probe cleaning apparatus 1 includes, as illustrated in FIG. 1, a cleaning control unit 10, a probe 21, a probe card 22, a laser generating device 31, an optical system 32, a stage 33, an electrical-characteristics measuring unit 41, and an image acquiring unit 42.

The probe card 22 is a card on which an arbitrary number of the probe 21 are arranged. The optical system 32 emits a laser beam, which is generated by the laser generating device 31, to the probe 21. The optical system 32 corresponds to a laser-beam emitting unit. The optical system 32 is mounted on the stage 33 movable in a horizontal direction and a vertical direction with respect to the probe 21 so as to locate the optical system 32 at a desired position by movement of the stage 33.

The electrical-characteristics measuring unit 41 measures electrical characteristics of a test object with the probe 21 being in contact with the test object. The test object and a driving mechanism that moves the test object onto the probe 21 are not illustrated in FIG. 1. The image acquiring unit 42 is a camera unit that shoots an image of the probe 21 to monitor a status of the probe 21.

The cleaning control unit 10 controls probe cleaning, i.e., removal of contaminations from the probe 21 of the probe cleaning apparatus 1. The cleaning control unit 10 includes a status check unit 11, a main control unit 12, a cleaning-conditions database 13, a stage control unit 14, an optical-system control unit 15, and a laser control unit 16.

The status check unit 11 checks the status of the probe 21 using a result of the measurement by the electrical-characteristics measuring unit 41 and the image that is acquired by the image acquiring unit 42. The cleaning-conditions database 13 stores therein laser irradiation conditions in associated with properties of the probe 21, such as material and shape.

The stage control unit 14 moves the stage 33 under control of the main control unit 12. The optical-system control unit 15 changes arrangement of the optical system 32, thereby adjusting a focal point or a shape of the laser beam to be emitted under control of the main control unit 12.

The laser control unit 16 controls operations of the laser generating device 31 under control of the main control unit 12. More particularly, the laser control unit 16 includes an output setting unit 16a that sets an output of the laser beam; a frequency setting unit 16b that sets a frequency of pulses to be emitted, i.e., a pulse interval of the laser beam; a wavelength setting unit 16c that sets a wavelength of the laser beam; and a pulse-width setting unit 16d that sets a width of the pulse.

The main control unit 12 controls cleaning processes. The main control unit 12 controls the stage control unit 14, the optical-system control unit 15, and the laser control unit 16 using a result of the check by the status check unit 11 and data contained in the cleaning-conditions database 13 in such a manner that the contaminations are removed from the probe 21.

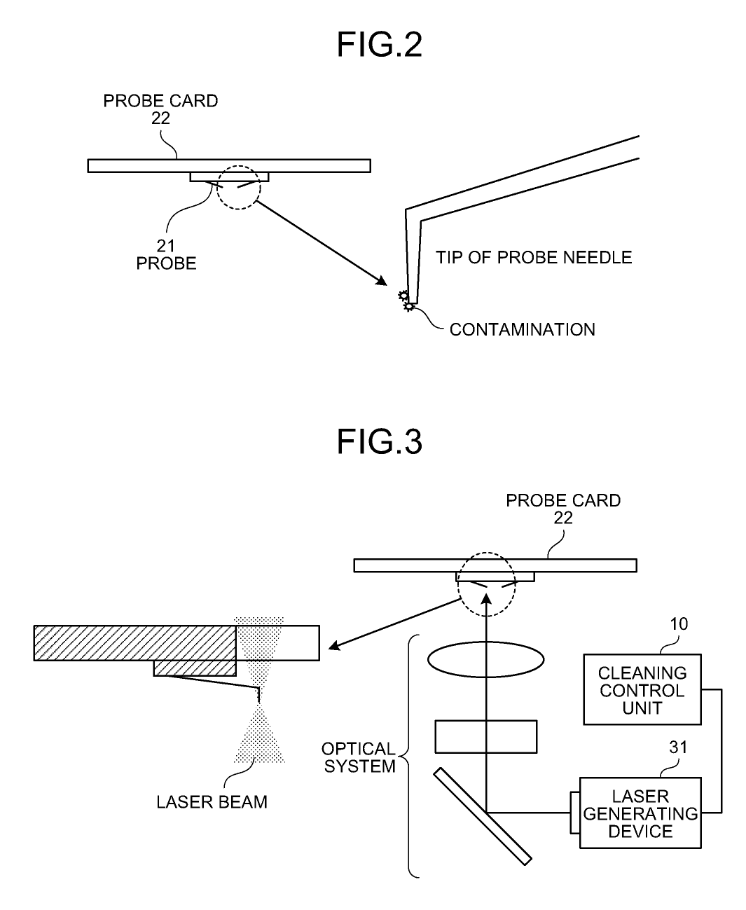

FIG. 2 is a schematic diagram for explaining how contaminations are attached to the probe 21. The probe card 22, as illustrated in FIG. 2, includes a resin substrate having wires and at least one needle, as the probe 21, on the resin substrate. Various tests are conducted with the probe 21 by coming in contact with the surface of the test object.

As the tip of the probe 21 comes in contact with the surface of the test object, such as a substrate, more times for the test, more contaminations are attached to the tip of the probe 21 so as to form accumulation. The contaminations include metallic materials, such as aluminum and gold, and foreign particles floating in the air. The contamination has various sizes and various properties.

FIG. 3 is a schematic diagram for explaining the probe cleaning (i.e., removal of the contaminations from the probe 21) by laser irradiation. The laser beam is emitted from the laser generating device 31 to the tip of the probe 21 via the optical system 32. The laser beam is converted to a laser beam with a pulse width less than 10 nanoseconds (nsec) by optical elements of the optical system 32, and the converted laser beam is focused on the front side of the tip of the probe 21. Thus, the contaminations are removed from the tip of the probe 21. The pulse width of the laser beam is set short, i.e., less than 10 nsec so that the tip of the probe 21 cannot be damaged by the laser beam.

When the tip is irradiated with the laser beam, the surface of the probe 21 near the tip and the resin surface of the probe card 22 are also irradiated with the laser beam. However, because the laser beam is focused on the front side or the right or left side of the tip, the area away from the tip is exposed with the diverged laser beam. Therefore, the surface of the probe 21 and the probe card 22 away from the needle tip cannot be damaged.

The laser generating device 31 generates the laser beam under control of the cleaning control unit 10. The cleaning control unit 10 includes the cleaning-conditions database 13 that stores therein a plurality of patterns of laser irradiation conditions. The cleaning control unit 10 acquires information about the probe card 22 and the probe 21 and sends the proper pattern of the laser irradiation conditions so that the laser generating device 31 can emit the proper laser beam.

The cleaning-conditions database 13 stores therein data on the laser conditions, such as output intensity, frequency, wavelength, pulse width, etc. in associated with object conditions, such as material for the probe 21, composition of the contaminations, size of the contamination, etc.

Suppose, for example, a case where the contaminations are to be removed from the tip of the probe 21 made of tungsten with the tip diameter about 20 micrometers (μm). In this case, the front side of the tip of the probe 21 is irradiated with a near-infrared laser beam with the wavelength 1,064 nanometers (nm), the pulse width 7 nsec, and the energy per pulse 40 μJ. The laser diameter is focused in such a manner that the beam diameter decreases to about 50 μm at the tip of the probe 21 via the optical elements positioned along an optical axis between the laser generating device 31 and the probe 21.

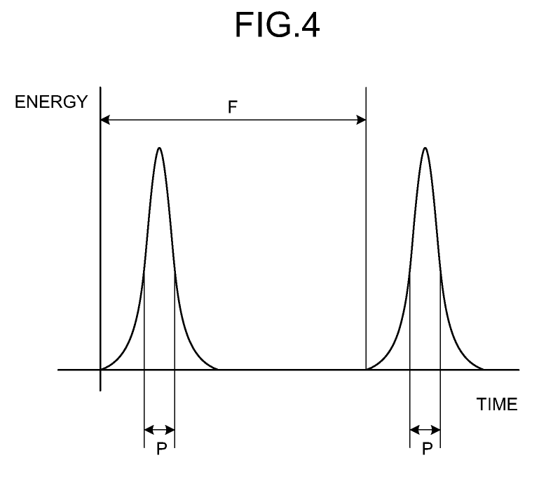

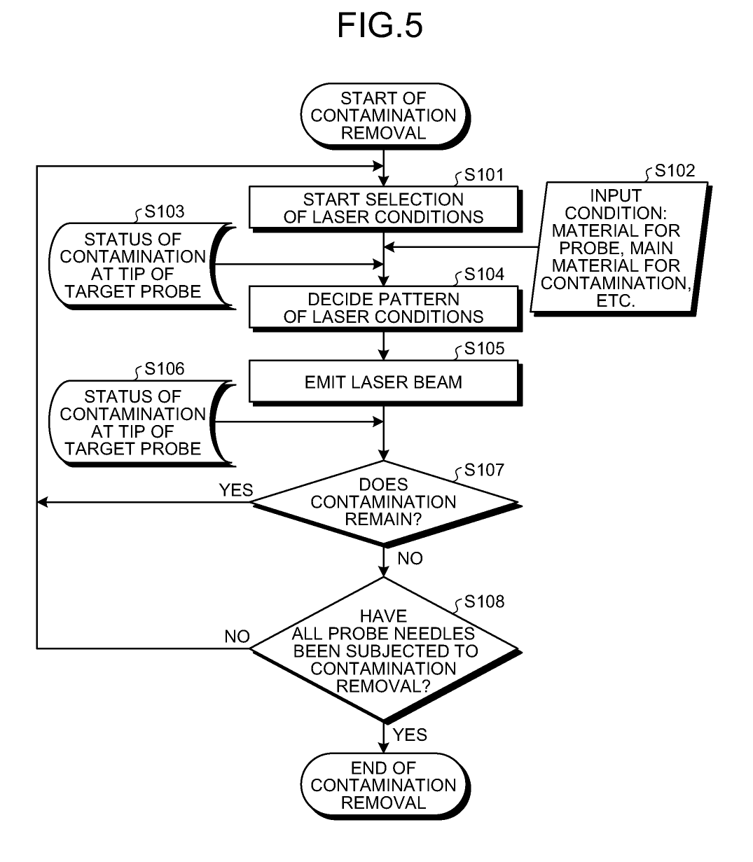

FIG. 4 is a pulse diagram of the laser beam. As illustrated in FIG. 4, the laser beam with a frequency F and a pulse width P is used for the laser irradiation. Although the surface irradiated with the laser beam (hereinafter, “irradiated surface”) heats due to the laser irradiation, the irradiated surface cools down before receiving the next shot by an effect of heat conduction.

However, if the probe 21 is continuously irradiated with the laser beam, the temperature on the irradiated surface increases gradually. Therefore, it is necessary to control the continuous laser irradiation, paying attention to the increase in the temperature on the irradiated surface. In this case, intervals between adjacent shots are set to 0.2 seconds (5 Hz).

At the end of the laser irradiation for removing the contaminations, the probe cleaning apparatus 1 checks whether the contamination remains on the tip of the probe 21 using the electrical characteristics of the probe 21 that are measured by the electrical-characteristics measuring unit 41 and image recognition with the image that is acquired by the image acquiring unit 42. If it is determined that the contamination still remains, additional shots of the laser beam are emitted to the probe 21. After that, the probe cleaning apparatus 1 checks again whether the contamination remains using the electrical characteristics and the image recognition.

FIG. 5 is a flowchart for explaining a cleaning process performed by the cleaning control unit 10. The cleaning control unit 10 selects a pattern of the laser irradiation conditions corresponding to the actual status before emitting the laser beam. More particularly, the cleaning control unit 10 starts selection of laser irradiation conditions (Step S101), and acquires information about the probe 21 and the contaminations to be removed, such as the material for the probe needle, the shape of the probe needle, and the main material for the contaminations. The above-described information is input and stored in a storage unit before the start of the cleaning process. The cleaning control unit 10 reads the required information from the storage unit (Step S102).

The cleaning control unit 10 acquires information about the status of the contamination attached to the tip of the probe needle, such as the contact resistance and the status, which is read from the image, how the contaminations are attached (Step S103). The status information is acquired or was acquired in the contamination removal.

The cleaning control unit 10 selects, based on the acquired information, a pattern of the laser irradiation conditions from the pre-stored patterns of the laser conditions (Step S104), and emits the laser beam satisfying the selected pattern of the laser irradiation conditions (Step S105). After the irradiation, the cleaning control unit 10 acquires the status of the tip of the target probe needle (Step S106), and checks whether contamination remains (Step S107).

If the contamination still remains (Yes at Step S107), the process control returns to Step S101. If the contamination does not remain (No at Step S107), the cleaning control unit 10 determines whether all the probe needles have been subjected to the contamination removal (Step S108).

If any of the probe needles are remained unprocessed (No Step S108), the process control returns to Step S101, and the unprocessed probe needle is subjected to the contamination removal. If all the probe needles has been subjected to the contamination removal (Yes at Step S108), the process control goes to end.

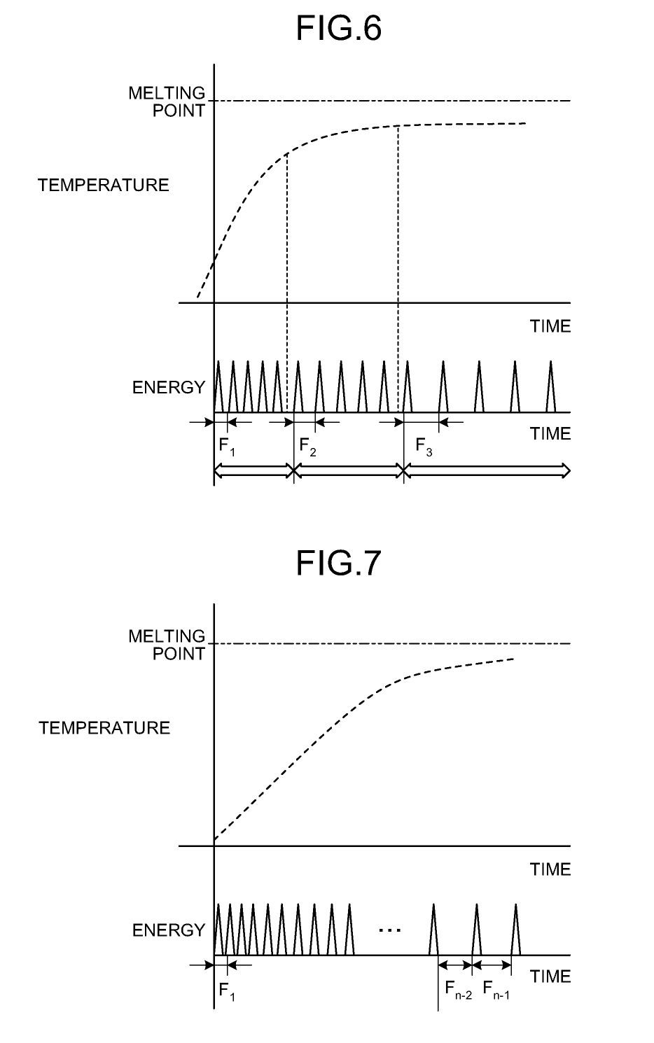

FIG. 6 is a graph for explaining probe protection that is achieved by controlling the pulse interval step by step. In the example illustrated in FIG. 6, the cleaning control unit 10 emits the laser beam in such a manner that the first group of five pulses is spaced at intervals F1, the second group of five pulses is spaced at intervals F2, and the third group of five pulses is spaced at intervals F3. The interval F2 is longer than the interval F1, and the interval F3 is larger than the interval F2.

FIG. 7 is a graph for explaining probe protection that is achieved by gradually increasing the pulse interval. In the example illustrated in FIG. 7, the cleaning control unit 10 sets a first pulse interval F1 to a last pulse interval Fn satisfying F1<F2<F3 . . . <Fn-2<Fn-1.

In this manner, the pulse intervals of the laser beam are decided able to avoid the damage to the probe that is caused when the temperature increases to the melting point due to too much energy that is accumulated in the probe.

It is allowable to control the pulse width using the patterns corresponding to the material and the shape of the probe. It is allowable to control the pulse interval using the temperature that is detected near the irradiated surface.

The temperature of the irradiated surface can be measured based on a temperature on a surface of the laser-beam emitting unit or the characteristics, such as the electric resistance, at an area surrounding the irradiated surface. If the laser beam is controlled in a manner similar to the example illustrated in FIG. 6, the laser beam is emitted at the pulse intervals F1, first. When the temperature on the irradiated surface increases to a first point, then the laser beam is emitted at the pulse intervals F2 to suppress the rate of the temperature increase. When the temperature on the irradiated surface increases to a second point, then the laser beam is emitted at the pulse intervals F3 to suppress the rate of the temperature increase. The first point and the second point are lower than the melting point. Thus, the contaminations are removed with the temperature on the irradiated surface being maintained below the melting point. In this manner, the probe cleaning apparatus 1 controls the laser irradiation by adjusting the pulse interval F in such a manner the temperature on the irradiated surface cannot exceed the melting point during the laser irradiation, which makes it possible to remove the contaminations without damaging the irradiated surface by the heat.

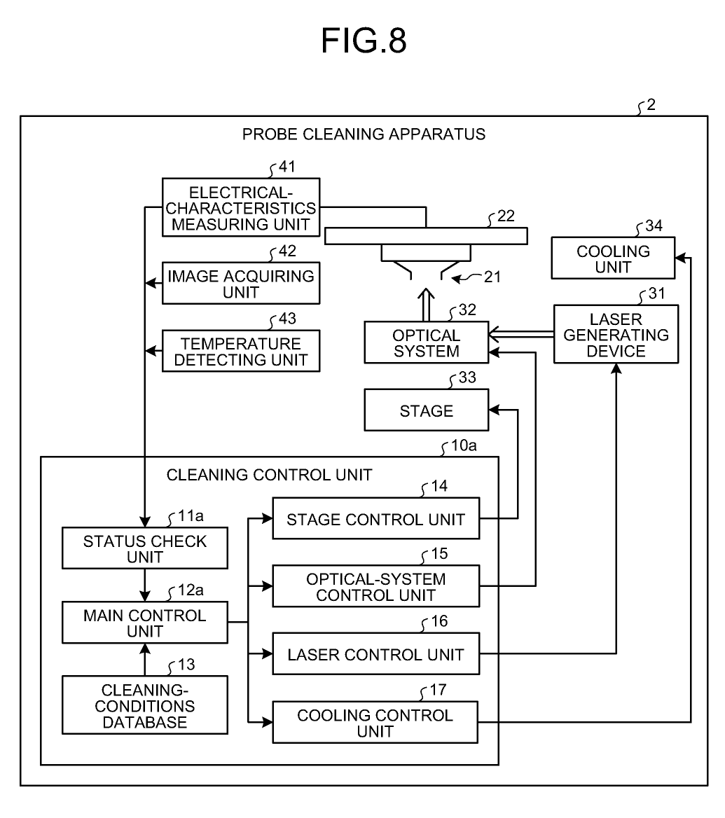

It is allowable to cool, by using a cooling unit and a control unit that controls the cooling unit, the surface to be irradiated or the irradiated surface before or during the laser irradiation so that the irradiated surface cannot be damaged by the heat. FIG. 8 is a block diagram of a probe cleaning apparatus 2 including a cooling unit 34 according to a second embodiment.

The configuration of the probe cleaning apparatus 2 is different from that of the probe cleaning apparatus 1 in which the probe cleaning apparatus 2 further includes the cooling unit 34 and a temperature detecting unit 43. The configuration of a cleaning control unit 10a is different from that of the cleaning control unit 10 in that a status check unit 11a further checks a result of the detection by the temperature detecting unit 43; and a main control unit 12a performs the laser control using the temperature that is detected by the temperature detecting unit 43 and controls operations of the cooling unit 34 via a cooling control unit 17. Parts corresponding to those in probe cleaning apparatus 1 are denoted with the same reference numerals, and the same description is not repeated.

The temperature detecting unit 43 measures the temperature on the irradiated surface using the temperature on the surface of the laser-beam emitting unit or the characteristics, such as the electric resistance, at an area surrounding the irradiated surface. The cooling unit 34 cools down the irradiated surface by, for example, blowing the irradiated surface with a cool wind during the laser irradiation. The cooling control unit 17 controls, under control of the main control unit 12a, the operation of the cooling unit 34 to artificially reduce the heat that is generated by the laser irradiation.

The examples using the pulse-interval control are described above as a manner of maintaining the temperature of the probe lower than the melting point, thereby preventing the damage by the heat. However, it is allowable to control the output intensity, the wavelength, and the pulse width of the laser beam instead of the pulse interval.

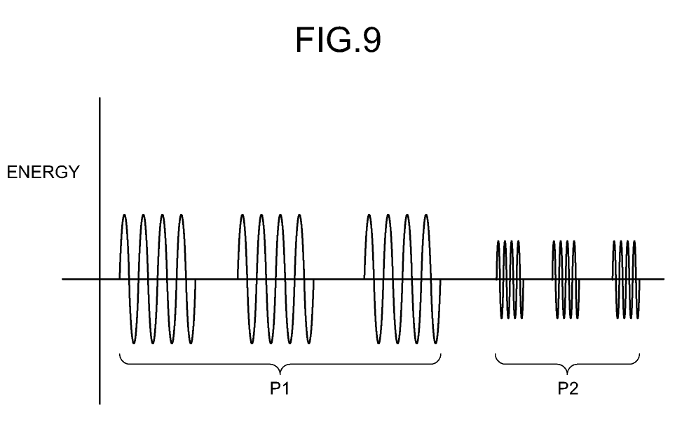

It is allowable to combine several patterns of the laser irradiation conditions, taking it into consideration that the contamination has various sizes. Suppose, for example, a case, with reference to FIG. 9, where the large contaminations are removed first, and then the small contaminations are removed. To remove the large contaminations, the laser beam with the wavelength 1,064 nm, the pulse width 7 nsec, the energy per pulse 50 μm is emitted three times. To remove the small contaminations, the laser beam with the wavelength 532 nm, the pulse width 5 nsec, the energy per pulse 80 μm is emitted seven times. In this manner, it is possible to efficiently remove the contaminations by the laser irradiation using the combined different patterns of the laser irradiation conditions. Moreover, the efficiency of the contamination removal will be improved, if the laser irradiation conditions are decided based on the material and the shape of the probe needle and the size data on the attached contaminations.

As described above, when removing the contaminations from the probe 21 by emitting the laser beam to the probe 21, the probe cleaning apparatus 1 according to the first embodiment and the probe cleaning apparatus 2 according to the second embodiment refer to the cleaning-conditions database 13 based on the information about the probe 21, such as the material and the shape, and controls the properties of the laser beam, such as the output intensity, the pulse interval, the wavelength, and the pulse width, so that the probe cleaning apparatuses 1 and 2 can remove the contaminations from the probe 21 without damaging the probe 21 by the heat.

More particularly, the probe cleaning apparatuses 1 and 2 remove the contaminations from the tip of the probe needle by emitting the pulsed laser beam with the pulse width less than 10 nsec to the tip of the probe needle from the front side or the right or left side of the probe needle. If the contamination still remains after the first shot of the laser beam, the pulsed laser beam with the pulse width less than 10 nsec is continuously emitted several times. More particularly, the laser beam is emitted continuously with the pulse interval that is controlled in such a manner that the temperature of the tip of the probe needle is maintained below the melting point even when the tip of the probe needle is continuously irradiated with the laser beam.

Although the probe needle of the probe card is subjected to the laser cleaning in the above embodiments, some other component can be subjected to the laser cleaning. It is applicable to, for example, removal of the contaminations from a silicon or glass substrate and a wafer. Moreover, it is applicable to an integrated circuit (IC) chip including patterns formed on a silicon substrate, and to a device having a two-dimensional or three-dimensional configuration, such as a MEMS (micro electro mechanical systems), is formed on a wafer of a glass substrate, etc. Still moreover, it is applicable to various molds, especially, a mold that is used to form another mold that supports a substrate or the like on which an IC chip is mounted. The mold is typically formed with a metallic (iron-based) substrate coated with a several-μm layer.

Furthermore, it is applicable to removal of foreign particles from a platinum substrate, and removal of foreign particles from a probe head that comes in contact with a solder ball that is formed on electronic paper or a BIT substrate.

According to the embodiments disclosed herein, it is possible to provide a method and an apparatus for laser cleaning in which contaminations are removed from an object in such a manner that the object cannot be damaged, i.e., melted by heat.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A laser cleaning apparatus comprising:
a laser-beam emitting unit that emits a laser beam to irradiate an object so that contamination is removed from a surface of the object; and
an irradiation control unit that controls irradiation by the laser beam based on information about the object so that an effect of the irradiation on the object is limited.

2. The laser cleaning apparatus according to claim 1, wherein
the laser-beam emitting unit repeatedly emits a pulsed laser beam; and
the irradiation control unit controls at least one of pulse width, output intensity, wavelength, number of pulses, and pulse interval of the laser beam.

3. The laser cleaning apparatus according to claim 2, wherein the irradiation control unit sets the pulse width less than 10 nanoseconds.

4. The laser cleaning apparatus according to claim 2, wherein the irradiation control unit gradually increases the pulse interval.

5. The laser cleaning apparatus according to claim 1, wherein the irradiation control unit controls the irradiation by the laser beam in such a manner that temperature of the object is maintained below a melting point.

6. The laser cleaning apparatus according to claim 1, further comprising a checking unit that checks a result of the irradiation by the laser beam, wherein
the irradiation control unit controls the irradiation by the laser beam based on a result of checking by the check unit.

7. The laser cleaning apparatus according to claim 1, wherein the irradiation control unit controls the irradiation by the laser beam based on material and shape of the object.

8. The laser cleaning apparatus according to claim 1, wherein the irradiation control unit controls the irradiation by the laser beam based on information about the contamination.

9. The laser cleaning apparatus according to claim 1, further comprising a cooling unit that cools the object.

10. The laser cleaning apparatus according to claim 1, wherein the object is a needle-shaped test probe that is used in a test for electrical characteristics of a test object, wherein a tip of the test probe is in contact with the test object in the test.

11. A laser cleaning method for removing contamination from a surface of an object by irradiating the object with a laser beam, the laser cleaning method comprising:
acquiring information about the object;
controlling irradiation of the laser beam based on the acquired information about the object so that an effect of laser cleaning on the object is limited; and
irradiating the object using the laser beam based on the controlled irradiation by the controlling.
